(19) United States
(12) Patent Application Publication
(10) Pub. No.: US 2008/0232929 A1
(43) Pub. Date: Sep. 25, 2008

(54) Breakable staple

(76) Inventors: Andrej King Jackson, Lancaster, CA (US); Ronald Howard Jackson, Lancaster, CA (US)

Correspondence Address: Andrej King Jackson, 44708 Benald St., Lancaster, CA, 93535, US

(21) Appl. No.: 12/077,800

(22) Filed: Mar. 19, 2008

Related U.S. Application Data
(60) Provisional application No. 60/918,819, filed on Mar. 19, 2007.

(51) Int. Cl. F16B 15/00

(52) U.S. Cl. 411/476

(57) ABSTRACT

The embodiment pertains to an improvement upon staples, (FIGS. 1A and 2) of the type used for fastening papers together (FIG. 5; 32) or other material(s) (FIGS. 6; 32), whereby the crown of a conventional staple is impressed with one or more breaking point(s) (FIGS. 1A, 1B, 1C and 2; 18, 24), allowing the staple crown to be manually extricated (FIGS. 7 and 8; 28) from the staple prong(s) (FIGS. 7 and 8; 26, 30) and paper or material (FIGS. 7 and 8; 32) with the lift, pull, or push of the staple crown.

### CROSS-REFERENCE TO RELATED APPLICATIONS

This application claims the benefit of provisional patent application Ser. No. 60/918,819 Filed 2007 Mar. 19 by the present inventors.

### FEDERALLY SPONSORED RESEARCH

Not Applicable

### SEQUENCE LISTING OR PROGRAM

Not Applicable

### BACKGROUND

1. Filed of Invention

This present invention generally relates to staples, specifically the type used to fasten paper(s) together and to fasten other material(s) together.

2. Prior Art

From corporate offices, schools, manufacturers, as well as anyone use to using the conventional staple (non-breakable staple) all have need not to just fasten paper and/or material together, but to unfasten those things without the use of a hand held device.

Conventional staples U.S. Pat. No. 0,960,206 to Silverstein (1910), and U.S. Pat. No. 2,383,135 to Lang (1945) securely fasten paper together but can cause a problem if user is away from a staple remover and in need to remove paper from within a group of papers. The conventional staple forces the user to tear away paper (if staple remover isn't available) from within a group of papers which produces an unattractive or unprofessional looking piece of paper, or the user is forced to turn the group of conventional stapled paper around to the back and unfasten the clinched staple prongs away which becomes very uncomfortable and time consuming.

Though paper clips U.S. Pat. Nos. 2,781,566 to William Lee Hammer (1935) and D344545 to Chin Y Tsai (1992) need no hand held device for unfastening, they don't fasten papers securely.

Although U.S. Pat. Nos. 3,756,550 to Gerhard Kollitz (1972) and 4,332,060 to Hisao Sato (1980) represents the spring-loaded clips, also called binder clips, with handles are available for fastening papers, and the papers are securely fastened, but the clips are relatively expensive and are bulky. Furthermore these types of devices are also installed by hand, thus storage of the fasteners is not in a machine, such as a stapler, as the present embodiment is stapled with and stored in.

There's a “Staple removeable by hand” U.S. Pat. No. 5,893,695 to Martin Otis Steven (1999) were there's an over sized elongated staple head (were a logo can be placed) that extends away from both prongs to be used as leverage. The problem is, it's relatively expensive to manufacture.

Insofar as we are aware, no device formally manufactured is known for fastening documents together in an inexpensive and expeditious manner and be unfastened by hand without the use of a mechanical device. Also, no device is known whose holding power is that of a conventional staple and yet still able to be stapled by and stored in a mechanical device, a stapler.

### SUMMARY

The principal object of the present embodiment is an improvement on the staple in that a breakable staple can be easily removed by hand without a mechanical device, as can be a paperclip, yet provides the same holding power of a conventional staple.

The foregoing object can be accomplished by impressing one or more breaking point(s) into the top surface and/or underside of a conventional staple crown, or in the front side and/or backside of the conventional staple crown and/or in its prongs, thus having means that allows user to break away crown of staple from a parallel to a non parallel position, non-relative to its staple prongs and paper or other material, with a lift, pull or push of the staple crown with a finger nail and/or thumbnail of digit or digits of one's hand, without the aid of a mechanical device.

### DRAWINGS

### Figures

In the drawings, related figures have the same number but different alphabetic suffixes.

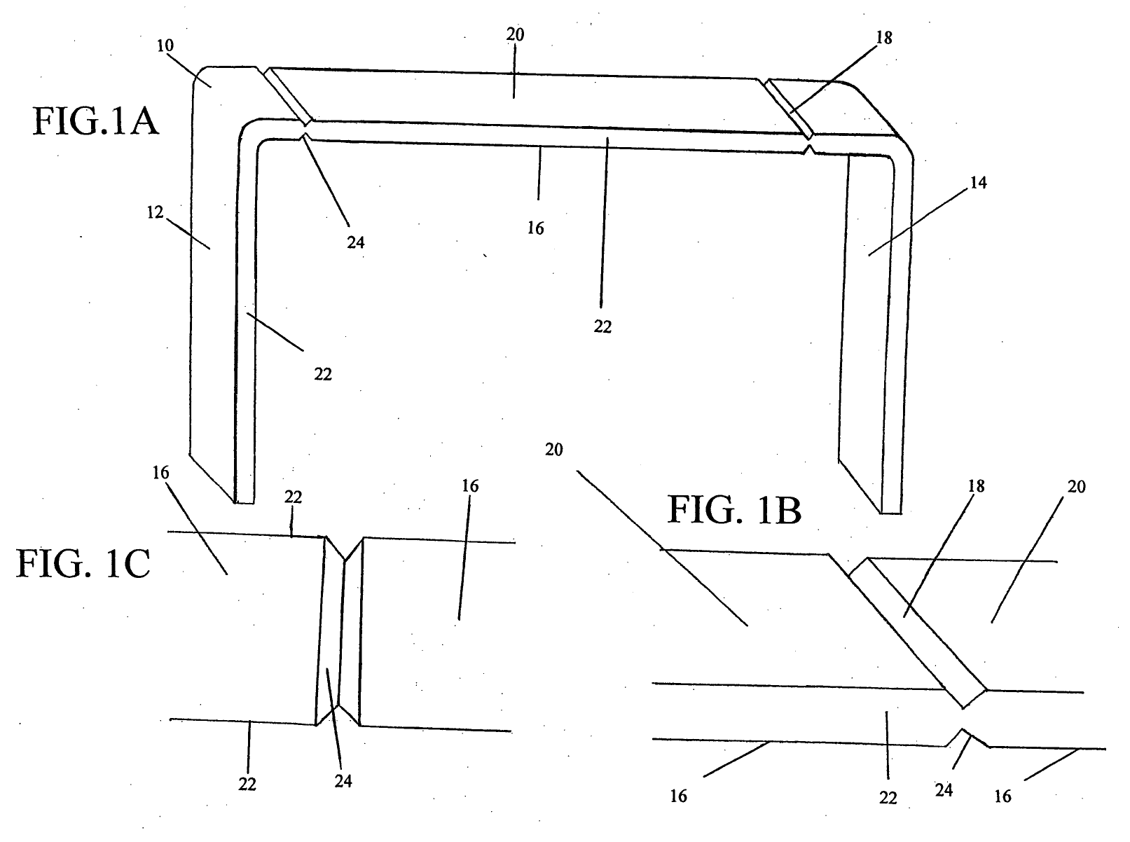

FIG. 1A is a perspective enlarged tilted top, side view of the breakable staple constructed in accordance with one embodiment. With the integral curve of the staple 10, along with the prong of staple and its outer sidewall view 12 as well as the prong and its inner sidewall view 14, the crown and its underside and length (underside view not shown, refer below to FIG. 1C of our patent) 16, and a top tilted view of the breaking point impression 18. The crown and its top surface and length 20 and the front side or backside view of staple 22 along with underside breaking point impression (underside breaking point impression view not shown, refer below to FIG. 1C of our patent) 24.

FIG. 1B is a magnified tilted top partial view of (FIG. 1A) with the crown and its underside (underside view not shown, refer below to FIG. 1C of our patent) 16 and the breaking point impression 18 as well as the crown and its top surface 20 along with front side or backside view of staple 22 and the underside breaking point impression (underside breaking point impression view not shown, refer below to FIG. 1C of our patent) 24 constructed in accordance with one embodiment.

FIG. 1C is a magnified underside partial view of (FIG. 1A) with the crown and its underside 16 and the front side or backside of staple (front side or backside of staple view not shown, refer above to FIGS. 1A and 1B of our patent) 22 and the underside view of the breaking point impression 24 constructed in accordance with one embodiment.

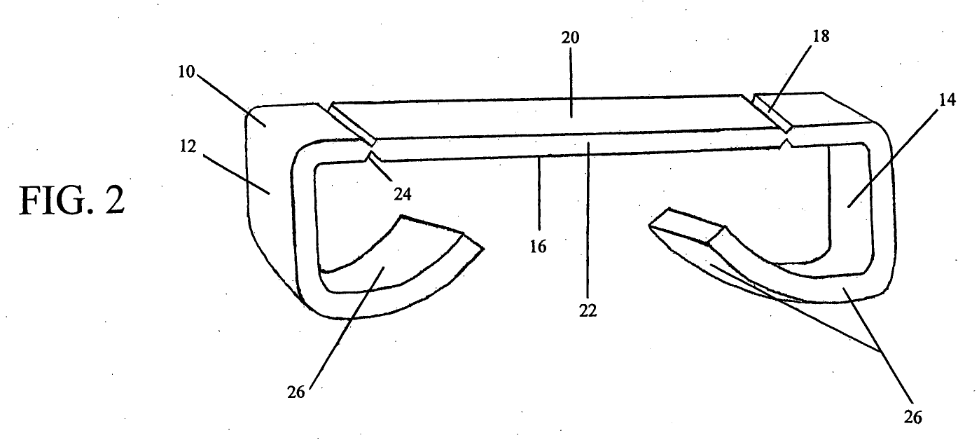

FIG. 2 is a perspective enlarged lilted top, side view of the breakable staple of (FIG. 1A) but in a clinched prong stapled position 26 constructed in accordance with one embodiment. The integral curve 10 of staple, along with the clinched prong 26 of the staple and its outer sidewall view 12 and another clinched prong 26 and its inner sidewall view 14. The crown and its underside and length (underside view not shown, refer above to FIG. 1C of our patent) 16, and a top tilted view of the breaking point impression 18. The crown and its top surface and length 20 and the front side or backside view of staple 22 along with the underside breaking point impression (underside breaking point impression view not shown, refer above to FIG. 1C of our patent) 24.

FIG. 3 is a perspective enlarged tilted top, fragmented view of a used breakable staple with the crown of staple 28 separated from the staple curves 10 and the stapled clinched prongs 26.

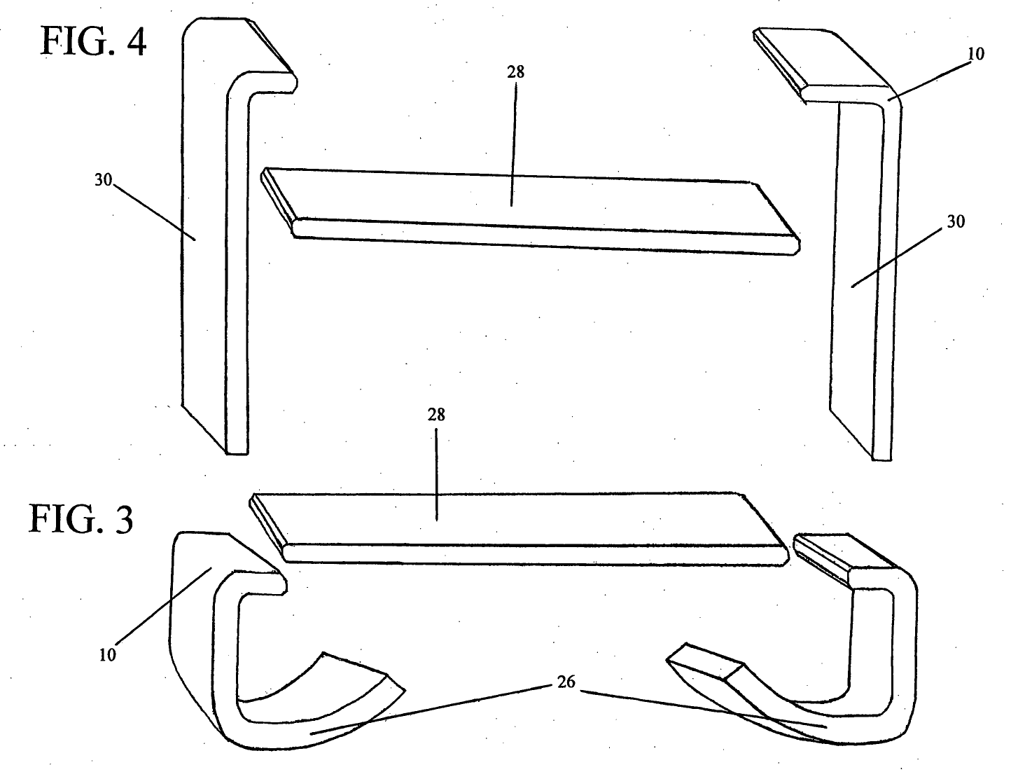

FIG. 4 is a perspective enlarged tilted top, fragmented view of a used breakable staple with the middle of staple 28 separated from the staple curves 10 and staple prongs 30.

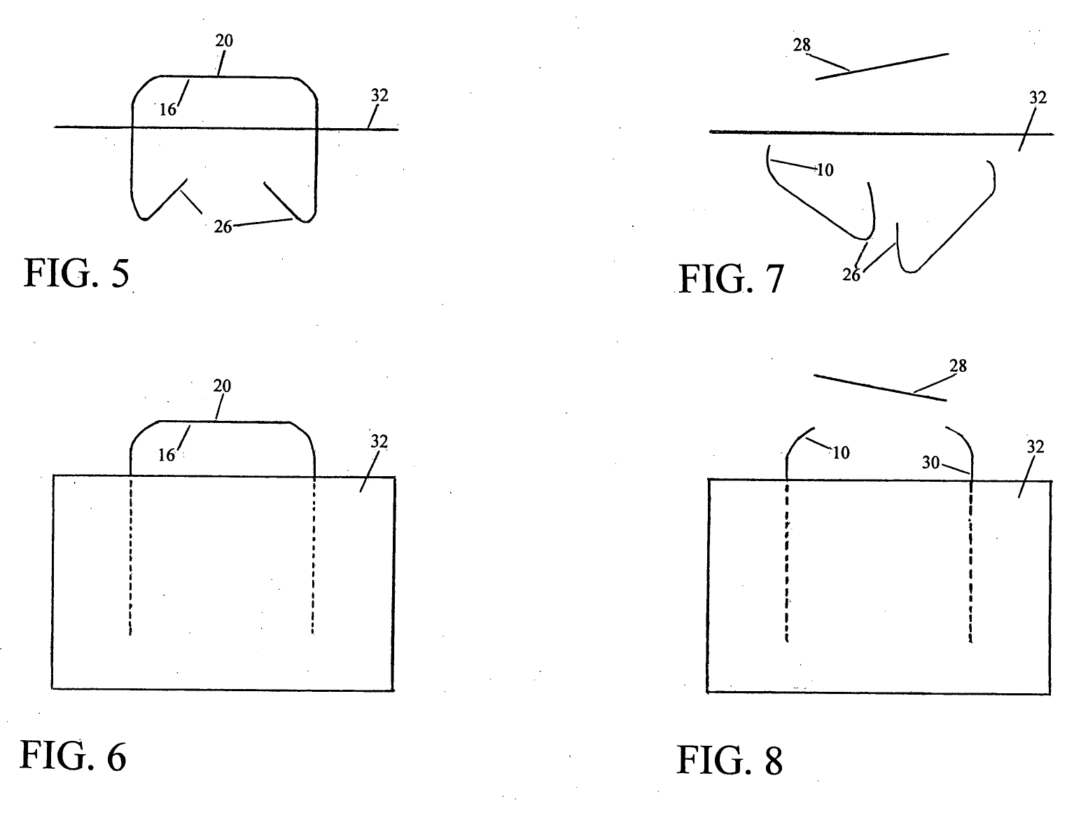

FIG. 5 is a perspective enlarged clinched prong view 26 of the present embodiment of (FIG. 2) (refer above to FIG. 2 for complete specifications in our patent) with the staple crown and its underside and length 16 and the crown and its top surface and length 20 stapled into paper and/or material 32 constructed in accordance with one embodiment.

FIG. 6 is a perspective enlarged view of the present embodiment of (FIG. 1A) (refer above to FIG. 1A for complete specifications in our patent) with the staple crown and its underside and length 16 and the crown and its top surface and length 20 stapled into paper or material 32 constructed in accordance with one embodiment.

FIG. 7 is a perspective enlarged fragmented view of a used breakable staple shown after the staple crown 28 have been separated from the staple curves 10 and the staples clinched prongs 26, and paper or material 32.

FIG. 8 is perspective enlarged broken off view of a used breakable staple shown after staple crown 28 have been separated from the integral staple curves 10 of prongs 30, and material 32.

DRAWINGS-Reference Numerals

| | | | |
|---|---|---|---|
| 10 | integral curves of staple | 12 | prong and its outer sidewall |
| 14 | prong and its inner side wall | 16 | crown or head and its underside and |
| 18 | breaking point impression(s) | | length |
| | (In the top of crown view.) | 20 | crown or head and its top surface and |
| 22 | front side or backside of staple | | length |
| | (The crown, curves, prongs or clinched prongs.) | 24 | breaking point impression(s) |
| 26 | clinched prongs | | (In the underside of crown view.) |
| 30 | prongs separated from crown | 28 | crown or head of staple separated |
| 34 | breaking point impression(s) | | from prongs |
| | (In the inner sidewall prong(s) | 32 | paper or material |
| | of the additional embodiments.) | 36 | breaking point impression(s) |
| | | | (In the outer sidewall prong(s) |
| | | | of the additional embodiments.) |

### DESCRIPTION OF THE PREFERRED EMBODIMENT

### FIGS. 1A, 2, 3 and 4

Refer now to FIGS. 1A and 2, which are enlarged tilted top, side views, and FIGS. 1B and 1C, which are magnified views of FIGS. 1A and 2 of a preferred embodiment, an improved staple. The breaking point impressions 18 in the top of the crown 20 are adjacent to or precisely across to the breaking point impression(s) 24 in the underside of the crown (FIG. 1C) 16. In these examples, the breaking point impressions 24, 18 are in the left and right of the crown 16, 20 and are substantially before its integral staple curves 10 and prongs 12, 14, to allow one to place one's fingernail and/or thumb nail of digit or digits of one's hand between the underside of the crown 16 of staple and the paper or material (FIGS. 5 and 6; 32), in order to allow for complete separation from staple curves of the clinched prongs or prongs (FIGS. 7 and 8; 10, 26, 30) after the breaking point impressed crown 16, 18, 20, 24 is lifted, pulled or pushed into a non-parallel position, non relative to the paper or material (FIGS. 7 and 8; 28, 32). The overall length of the breaking point impressed crown 16, 18, 20, 24 is sufficient to produce adequate leverage for one to extricate staple crown from the staple curves 10, and clinched prongs or prongs (FIGS. 3, 4, 7, and 8; 26, 28, 30), and paper or material (FIGS. 7 and 8; 32) with the lift, pull or push of the staple crown, unaided by a mechanical device.

Refer now to FIGS. 3 and 4 which are enlarged tilted top fragmented side views of FIGS. 1A and 2 of the preferred embodiment. The breaking point impressions of the staple crown (FIGS. 1A, 1B, 1C, and 2; 18, 24) will implement breakage after adequate stress has been applied to them from the lift, pull or push of the staple crown 28. Also, the breaking point impressions of the crown (FIGS. 1A, 1B, 1C and 2; 18, 24) are broken away 28 by using the crown and its underside (FIGS. 1A and 2; 16) as leverage, which causes the staple crown to become extricated 28 in a non-parallel position, non relative and non integral to the staple curves 10 of the clinched prongs 26 or prongs 30, and paper or material (FIGS. 7 and 8; 32), after having been stapled through (FIG. 5) or in them (FIG. 6).

### OPERATION

### FIGS. 1A, 2, 5, 6, 7, and 8

The manner of using the breakable staple to fasten paper or material is identical to that for conventional staples in present use. Namely, one first assemble sheets of paper together or other material (FIGS. 5 and 6; 32) in a homogenize configuration. Next, handle paper or material 32 in preparation to be fastened by a mechanical fastening storage device, a stapler, henceforth impelling breakable staple (FIG. 1A) with means of piercing through (FIG. 5) or into (FIG. 6) paper or material 32 until grounded in a clinched prong position (FIGS. 2 and 5; 26) or prong position (FIG. 1A; 12, 14 and FIG. 6) parallel relative to the paper or material 32.

To remove the breakable staple, one first handle the paper or material 32 to allow one to place one's finger nail and/or thumbnail of digit or digits of one's hand between the underside of the breaking point impressed staple crown (FIGS. 5 and 6; 16,) and the paper or material 32, henceforth using crown of staple (FIGS. 5 and 6; 16, 20,) as leverage. Next, user will lift, pull or push the crown of staple 16, 20, means for implementing stress in the breaking point impression(s) of the crown (FIGS. 1A, 1B, 1C, 2; 18, 24), which causes breakage, and separation of the staple crown 28 from the staple curve(s) 10 of the clinched prong(s) 26 or prong(s) 30. Now the extricated staple crown is in a nonparallel position (FIGS. 7 and 8; 28), and non-integral to the staple curve(s) 10 of the clinched prong(s) 26 or prong(s) 30, and non relative to the paper or material 32.

In the removal aspect of the operation, the breakable staple (FIGS. 5 and 6) allows its user to have an easier and expeditious solution in unfastening paper of other material 32. Furthermore, in the removal of the staple, it eliminates the user from tearing away paper(s) from within a group of fastened papers (FIG. 5; 32) and prevents user from turning a group of papers around to become unfastened from the back (FIG. 5; 26, 32). Also, in the removal aspect of the breakable staple, the procedure and conclusion is without the aid of a mechanical device, a staple remover.

### DESCRIPTION

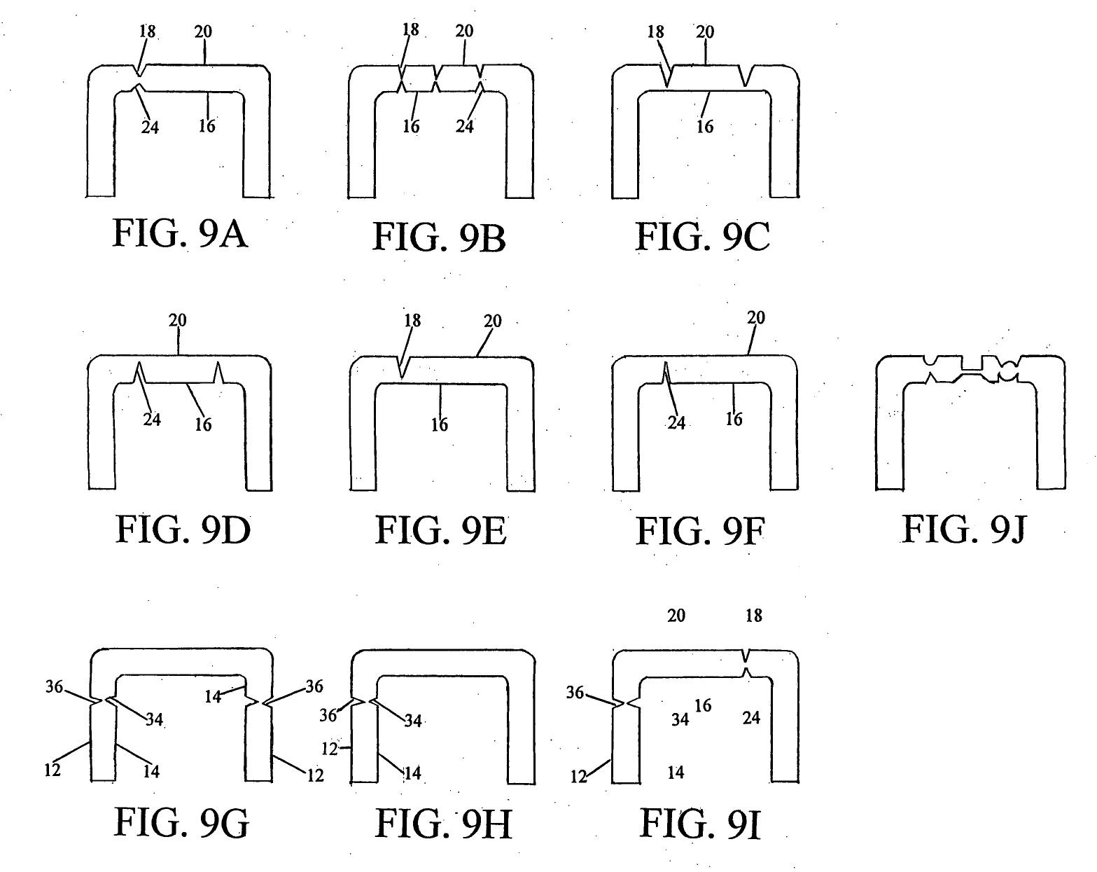

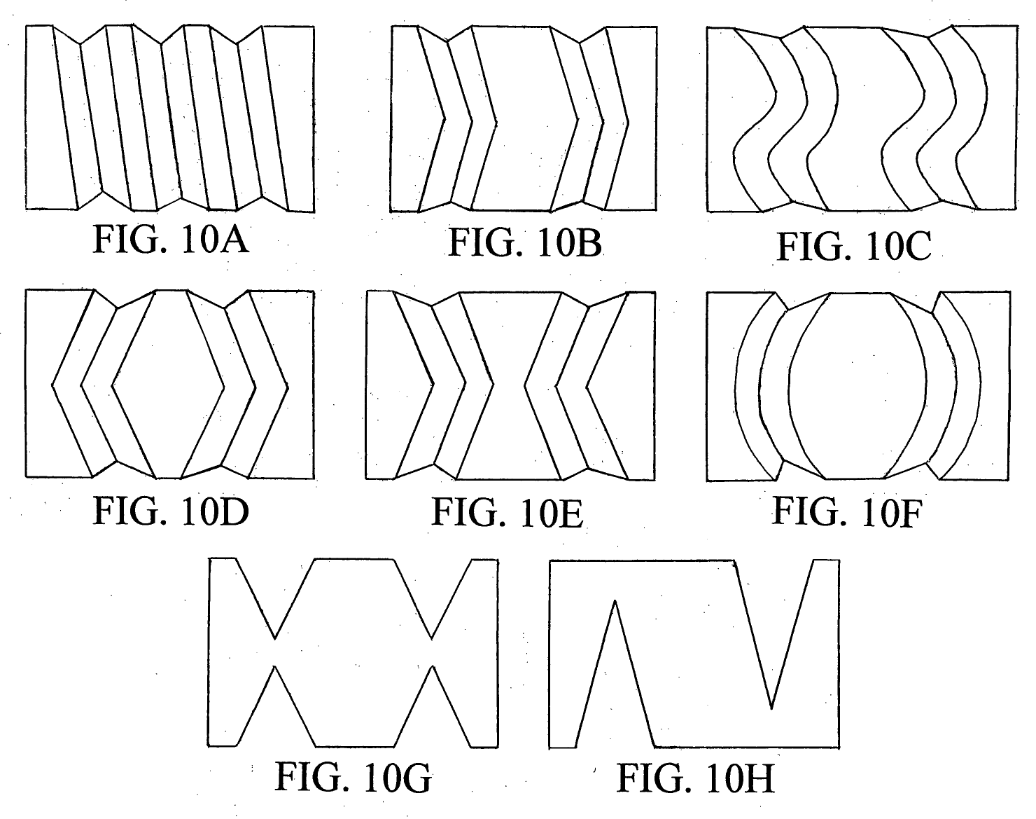

### Additional Embodiments—FIGS. 9A Through 9J

Additional embodiments are shown in FIGS. 9A through 9J; in each case the breaking point impression(s) are shown in different locations relative to the embodiments. In FIG. 9A the breaking point impression 18 in the top of the crown 20 is adjacent to or precisely across to the breaking point impression 24 in underside of the crown 16; in FIG. 9B the breaking point impressions 18 in the top of the crown 20 are adjacent to or precisely across to the breaking point impressions 24 in underside of the crown 16; in FIG. 9C the breaking point impressions 18 in the top of the crown 20 is impressed deeper towards underside of the crown 16; in FIG. 9D the breaking point impressions 24 in the underside of the crown 16 is impressed deeper towards top of the crown 20; in FIG. 9E the breaking point impression 18 in the top of the crown 20 is impressed deeper towards underside of the crown 16; in FIG. 9F the breaking point impression 24 in the underside of crown 16 is impressed deeper towards top of the crown 20; in FIG. 9G the breaking point impressions 34 in the inner sidewalls of the prongs 14 are adjacent to or precisely across to the breaking point impressions 36 in the outer sidewalls of the prongs 12; in FIG. 9H the breaking point impression 34 in the inner sidewall of the prong 14 is adjacent to or precisely across to the breaking point impression 36 in the outer sidewall of the prong 12; in FIG. 9I the breaking point impressions 34 in the inner sidewall of the prong 14 is adjacent to or precisely across to the breaking point impression 36 in the outer sidewall of the prong 12 as well as the breaking point impression 18 in the top of the crown 20 is adjacent to or precisely across to the breaking point impression 24 in underside of the crown 16; in FIG. 9J, it shows an example of some various shapes and/or forms the breaking point impression can hold relative to the top surface and/or underside of the staple crown, and though not shown in this example, the various shapes and/or forms can also be said of the inner side wall and/or outer sidewall of the prong(s).

### DESCRIPTION

### Alternative Embodiments—FIGS. 10A Through 10F

There are various possibilities with regard to the breaking point impression(s) relative to the staple crown and/or clinched staple prong(s) or prong(s) of the additional alternative embodiments, these are some as illustrated in FIGS. 10A through 10F, that presents different forms and/or shapes or letter like shapes. In FIG. 10A these are multiple diagonal breaking point impressions; in FIG. 10B these are arrow shaped breaking point impressions pointing one way; in FIG. 10C these are letter s like shaped breaking point impressions; in FIG. 10D these are arrow shaped breaking point impressions pointing away from each other; in FIG. 10E these are arrow formed breaking point impressions pointing towards each other; in FIG. 10F these are letter c like form breaking point impressions.

### DESCRIPTION

### Alternative Embodiments—FIGS. 10G and 10H

In FIGS. 10G and 10H these breaking point impressions are unlike the previous descriptions of the breaking point impressions above. These breaking point impressions are in the front side and/or backside of the staple crown and/or staple prong(s) (FIG. 1A; 22). In FIG. 10G these breaking point impressions are pointed away from the front side of the staple crown and/or staple prong(s), and are adjacent to or precisely across to the breaking point impressions that are pointing away from the backside of the staple crown and/or staple prongs; in FIG. 10H the breaking point impression is impressed deeper and is pointed away from the front side of the staple crown and/or prong(s), and is non adjacent to or non precisely across to the breaking point impression that's impressed deeper and is pointed away from the back side of the staple crown and/or prong(s).

### OPERATION

### Additional Alternative Embodiments—FIGS. 9A Through 10H

These are some examples in the removal operation of the additional alternative embodiments. In FIGS. 9A, 9E, and 9F only one side of the staple crown 16, 20 will become extricated from staple curve 10 and staple prong 12, 14 with the lift, pull or push of the staple crown 16, 20; in FIGS. 9B, 9C, 9D and 9J (FIG. 9J is an example of indefinite shapes and forms the breaking point impression can hold), the staple crown 16, 20 will become extricated from staple curves 10 and staple prong(s) 12, 14 with the lift, pull or push of the staple crown 16, 20; in FIG. 9G the staple crown 16, 20 along with staple curves 10 and some of the prong(s) 12, 14 will become extricated from the remaining staple prong(s) 12, 14 with the lift, pull or push of the staple crown 16, 20; in FIG. 9H only one side of the staple crown 16, 20 along with the staple curve 10 and some of the prong 12, 14 will become extricated from the remaining staple prong 12, 14 with the lift, pull or push of the staple crown 16, 20; in FIG. 9I the staple crown 16, 20 along with staple curve 10 and some of the prong 12, 14 will become extricated from the remaining staple curve 10 and staple prongs 12, 14 with the lift, pull or push of the staple crown 16, 20; in FIG. 10A the breaking point impressions will become stressed until broken from either side and/or in the middle; in FIGS. 10B through 10H the breaking point impressions will become stressed until broken from either side and/or both sides.

### CONCLUSION, RAMIFICATIONS, AND SCOPE

Accordingly, the reader will see that the breakable staple of the various embodiments can be used to fasten papers and other material easily and conveniently, can be removed just as easily and expeditiously without damage to fastened paper or material. In addition, the breakable staple is unfastened with out the aid of a mechanical device, a staple remover. The breaking point impressed crown has sufficient length to allow one to break away crown at the lift, pull, or push of a fingernail and/or thumbnail of digit or digits of ones hand. Furthermore, the breakable staple has the additional advantages in that
it permits the manufacturing from any viewpoint of the staple by permitting its size, form or shape to be altered or modified;
it permits the production from any viewpoint of the staples metal to be manufactured in various staple fibers, metal fibers, plastics, rubbers, nylon, synthetics or what the work place or private sector would call for, etc.;
it allows the breaking point impression(s) to be manufactured from any viewpoint of the staple (especially, in its top surface and/or in its underside of crown, and/or its inner, and/or outer side wall prong or prongs) and can appear in a vertical appearance and/or diagonal, and/or curve(s), and/or wave(s), and/or letter like appearances and any other appearance know to human beings; and
it permits the breaking point impression(s) to be manufactured from any viewpoint of the staple in means for appearing in any depth, width, size, form and shape or color; also
it allows the breaking point(s) to be manufactured from any viewpoint of the staple in that the staple head and prong(s) can be adhesively combined during production.

The foregoing description of the preferred embodiment of the invention has been presented for the purposes of illustration and description. It is not intended to be exhaustive or to limit the embodiment to the precise form disclosed. Many modifications and variations are possible in light of the above teaching.

Thus the scope of the embodiment should be determined by the appended claims and their legal equivalents, rather than by the examples given.

We claim:

1. In a fastener of the type to fasten paper or material wherein the improvement comprises of one or more prongs integral with a breaking point impressed head means for which the present embodiment can be removed from paper or material after said head is separated from clinched prongs or said prongs by lifting, pulling, or pushing on said head.

2. The fastener of claim 1 wherein said breaking point impression or said breaking point impressions with means for encumbering until broken by said head, when said head with means is lifted, pulled or pushed into a nonparallel position by a fingernail and/or thumbnail of a digit or digits of a hand inserted between said head and the paper or material.

3. The fastener of claim 2 wherein said breaking point impression or said breaking point impressions are in the top surface of said head and adjacent to or precisely across to the said breaking point impression or said breaking point impressions in the underside of said head.

4. The fastener of claim 2 wherein said breaking point impression or said breaking breaking impressions are in the front side of said head and adjacent to or precisely across to the said breaking point impression or said breaking point impressions in the backside of said head.

5. The fastener of claim 2 wherein said breaking point impression or said breaking point impressions are parallel in opposed lateral directions and/or center and/or multiple equidistant in top surface and/or in underside of said head.

6. The fastener of claim 1 wherein said breaking point impressed head having a length long enough to sufficiently produce adequate leverage whereby to lift, pull or push said head with a finger nail and/or thumbnail unaided by a mechanical device, using the underside of said head as leverage, to separate said head from said clinched prongs or said prongs.

7. A removable fastener of the type to fasten paper or material wherein the improvement comprises of one or more prongs, that are adapted to be clinched or non clinched, integral with a head means for separating such head from said clinched prongs or said prongs, wherein said head is impressed with said breaking point or said impressed breaking points, and/or said prong or said prongs is said impressed with said breaking point or said impressed breaking points to allow said head to be lifted, pulled or pushed by a fingernail and/or thumbnail of digit or digits of a hand, whereby the said head acts as a lever to increase the extrication force applied to the said breaking point impression or said breaking point impressions until broken from the said clinched prongs or said prongs or partial clinched prongs or partial prongs.

8. The removable fastener of claim 7 wherein said breaking point impression or said breaking point impressions with means for encumbering until broken by said head, when said head with means is lifted, pulled or pushed into a non-parallel position, non-relative to the said clinched prongs or said prongs and/or said partial prong or said partial prongs and paper and material.

9. The removable fastener of claim 7 wherein said breaking point impression or said breaking point impressions are in the inside wall of said prong or inside wall of said prongs and adjacent to or precisely across to the said breaking point impression or said breaking point impressions in the outer side wall of said prong or said prongs.

10. The removable fastener of claim 7 wherein said breaking point impression or said breaking point impressions are in the front side of said prong or front side of said prongs and adjacent to or precisely across to the said breaking point impression or said breaking point impressions in the backside of said prong or said prongs.

11. The removable fastener of claim 7 wherein said breaking point impression or said breaking point impressions are parallel in opposed lateral directions and/or center and/or multiple equidistant in said inner sidewall prong or said inner sidewall prongs.
